(19) United States
(12) Patent Application Publication
(10) Pub. No.: US 2017/0039361 A1
(43) Pub. Date: Feb. 9, 2017

(54) Method And Device For Fuzzily Inputting Password

(71) Applicants: Li Zheng, Dongguan (CN); Smart Electronic Industrial (Dong Guan) Co., Ltd., Dongguan (CN)

(72) Inventor: Li Zheng, Dongguan (CN)

(21) Appl. No.: 15/225,125

(22) Filed: Aug. 1, 2016

(30) Foreign Application Priority Data
Aug. 5, 2015 (CN) 201510473913.X

(51) Int. Cl. G06F 21/36; H04L 29/06; H04W 12/06

(52) U.S. Cl. CPC G06F 21/36; H04W 12/06; H04L 63/083

(57) ABSTRACT

A method for fuzzily inputting password includes the steps of: displaying a plurality of graph-text regions on a user interface, an information unit consisted of a plurality of information elements being mapped onto a corresponding graph-text region; obtaining a direction information detected by a gravity sensor, upon change of the direction information, a displaying angle of each graph-text region on the user interface being changed to show the plurality of graph-text layers which are arranged at equal pitch, each graph-text layer displaying an information element of an information unit associated with the same graph-text region; and selecting a specific information unit mapped with the graph-text region to verify whether a specific password character is identical to an information element of the unit. Also disclosed is a device for realizing the same method.

### CROSS REFERENCE TO RELATED APPLICATIONS

The present application claims priority from Chinese Patent Application No. 2015/10473913.X, filed Aug. 5, 2015, the disclosure of which is hereby incorporated herein by reference.

### FIELD OF THE INVENTION

The present invention relates to technology of electronic safety protection and more particularly, to a method and device for fuzzily inputting password.

### BACKGROUD OF THE INVENTION

With development of society, kinds of safety problems occur increasingly, and accordingly, users pay more attention to security. Nowadays mobile terminals such as smart phones or tablet computers usually are protected by power-on password, and have the function of encrypting private files. All these situations relate to application of inputting passwords with safety. Accordingly, it is especially important to safely input passwords, and it has been widely used in various aspects of routine life and work. For example, generally a display screen based on touch feedback is provided on a mobile terminal. Passwords may be input by inputting digits, passwords via touch-keys, taking a picture of human face, and drawing a line on a nine-grid frame. However, these means suffer from serious drawbacks. For example, inputting password by touch-keys or drawing a line on the nine-grid frame is susceptible to peeping by others and thus causing leakage of password. Human face picture inputting means may possibly be cracked by static pictures. Apparently, there is no sufficient concealment, reliability, and safety for above means.

In prior art techniques, there are various solutions for realizing fuzzy input of password. In one solution, a prompt character is displayed on a first key. Using this prompt key, the user selects a second key with which a true password character is associated. The user tries to input his password by this indirect mapping relationship. This however increases complexity especially in situations where time is limited for inputting. Therefore, this kind of solution is low efficient.

In another solution, a number of characters are mapped to a single key, among which only one is a password character. Once the user selects this key, input of a correct password character will be confirmed in accordance with the mapping relationship, this realizing password verification. Though this kind of inputting means has certain fuzziness and is intuitive to the user, concealment is insufficient.

From above discussion, it is desired to improve safety of password setting and verification and provide sufficient concealment of password inputting process.

### SUMMARY OF THE INVENTION

The objection of the invention is to overcome above drawbacks and provide a method and device for fuzzily inputting password.

To obtain the above objection, a method for fuzzily inputting password is proposed for realizing input of password characters during verification of a predefined password, and it includes the following steps:

displaying a plurality of graph-text regions on a user interface, an information unit consisted of a plurality of information elements being mapped onto a corresponding graph-text region;

obtaining a direction information detected by a gravity sensor, upon change of the direction information, a displaying angle of each graph-text region on the user interface being changed to show the plurality of graph-text layers which are arranged at equal pitch, each graph-text layer displaying an information element of an information unit associated with the same graph-text region; and

in response to user's selection a particular graph-text region, selecting a specific information unit mapped with the graph-text region to verify whether a specific password character is identical to an information element of the unit.

Preferably, the plurality of graph-text layer of a graph-text region is planes sharing a common central axis.

Preferably, a number of information elements are randomly contained in said plurality of information units such that the information elements contained in a specific information unit are different from each other.

Preferably, each information unit is displayed as a set of information elements of graph or codified type on a user interface at a location where a corresponding graph-text region locates.

Preferably, each information unit contains at least two information elements.

Preferably, the information elements are any one or a combination of character, color, font, font size, graphics or pattern.

Preferably, different information unit has different or same number of information elements.

Preferably, the method further includes a step of placing a sequence consisted of the plurality of information units, which are sequentially inputted in accordance with the number of the password characters, into a verification request, and submitting the verification request through a remote interface.

Preferably, the user interface is provided by a touch screen.

Preferably, the plurality of graph-text regions are displayed on the user interface with their locations unchanged.

Preferably, the plurality of graph-text regions are displayed on the user interface with their locations dynamically changed in real time.

A device for fuzzily inputting password for realizing the method as described above includes:

a control unit for executing a program embodying the method;

a storage unit for storing intermediate and result data generated during a process of executing the program realized according to the method; and

a touch screen for providing a displaying area for showing the plurality of graph-text regions and receiving selection instruction of the user.

A method for fuzzily inputting password, for inputting a password character during verification of a predefined password, includes the following steps:

displaying a plurality of graph-text regions on a user interface, an information unit consisted of a plurality of information elements being mapped onto a corresponding graph-text region;

obtaining a direction information detected by a gravity sensor, upon change of the direction information, a displaying angle of each graph-text region on the user interface being changed to show the plurality of graph-text layers which are arranged at equal pitch, each graph-text layer displaying an information element of an information unit associated with the same graph-text region; and

in response to user's selection a particular graph-text layer of a graph-text region, selecting a specific information element displayed on the graph-text layer to verify whether a specific password character is identical to the information element.

Preferably, the plurality of graph-text layer of a graph-text region is displayed with equal pitch along a common central axis, and an information element of an information unit corresponding to the graph-text region is displayed on a corresponding graph-text layer.

Preferably, a corresponding graph-text layer receives selection instruction of the user to determine the selected information element.

Preferably, receiving the selection instruction of the user is realized by sensing pressing strength of the user on a graph-text layer by a gravity sensor to determine the graph-text layer selected by the user, thus determining the information element corresponding to the same graph-text layer.

Preferably, a number of information elements are randomly contained in said plurality of information units such that the information elements contained in a specific information unit are different from each other.

Preferably, each information unit contains at least two information elements.

Preferably, the information elements are any one or a combination of character, color, font, font size, graphics or pattern.

Preferably, different information unit has different or same number of information elements.

Preferably, each information unit is displayed as a set of information elements of graph or codified type on a user interface at a location where a corresponding graph-text region locates.

The method further comprises a step of placing a sequence consisted of the plurality of information units, which are sequentially inputted in accordance with the number of the password characters, into a verification request, and submitting the verification request through a remote interface.

A device for fuzzily inputting password for realizing the method as mentioned above, includes:

a control unit for executing a program embodying the method;

a storage unit for storing intermediate and result data generated during a process of executing the program realized according to the method; and

a touch screen for providing a displaying area for showing the plurality of graph-text regions and receiving selection instruction of the user.

Compared to prior art, the embodiments of the instant invention bears the following good effects:

At first, a set of information elements are by default or randomly divided into plural information units each including at least information elements. Moreover, each information unit contains at least two information elements. Each information unit is displayed on a user interface on which a plurality of predefined graph-text regions are located for receiving selection of a specific region by the user. As such, selection of a specific region by the user is mapped onto one or more information elements, thus improving fuzziness of chosen information elements. Even in case those selection actions of the user have been seen by others, the true password sequence is still unknown to others, thereby enhancing security of the password inputting and verification process.

Secondly, each information unit is shown as a corresponding graph-text region, all of the information elements contained in a specific information unit associated with the graph-text region are shown as respective graph-text layers of the same region which form a virtual space. When a device is tilted such that its gravity sensation change is detected, corresponding information elements will be displayed. This design further enhances concealment of password inputting process. By simple clicking actions of the user, selection and inputting of one or more information elements is realized. By this manner, the entire password fuzzy input becomes simple and controllable, thus improving efficiency of password input, and bringing better user experience.

Finally, when the method of the invention is implemented by a program, commands for realizing a verification algorithm are reduced, and commands for realizing graphical display is enhanced, hence reducing risk of the command being intercepted and cracked during transmission of the command.

### BRIEF DESCRIPTION OF THE DRAWINGS

FIG. 1 shows a flowchart of a method for fuzzily inputting password according to one embodiment of the invention;

FIG. 2 shows a block diagram of a device for fuzzily inputting password according to one embodiment of the invention;

FIG. 3 shows a flowchart of a method for fuzzily inputting password according to another embodiment of the invention; and

FIG. 4 shows a block diagram of a device for fuzzily inputting password according to another embodiment of the invention.

### DETAILED DESCRIPTION OF THE INVENTION

Various embodiments of the invention are described below in detail. The examples of these embodiments are illustrated in the drawings. Throughout the drawings, same or similar numerals are used to refer to the same or similar elements or those having the same or similar function. The description of the embodiments in conjunction with the drawings is only exemplary for explaining the principle of the invention and is not to be interpreted to limit the invention.

It should be understood by person of the ordinary skill in the art that unless otherwise specified, terms “a”, “one”, “the” and “said” in singular form may also be used in plural form. It should be further understood that the term “include” as used herein means presence of said feature, integer, step, operation, element and/or component, but not excluding presence of one or more additional other feature, integer, step, operation, element and/or component and/or their combination. The term “and/or” includes one or more related elements and all combination thereof.

It should be understood by a person of the ordinary skill in the art that unless otherwise specified, all the terminology (including technical and scientific terms) have their ordinary meaning as understood by person of the art.

It should also be understood by a person of the ordinary skill in the art that the device (or terminal, or terminal device) of the invention may include a device of a wireless signal receiver capable of only receiving signals while not being capable of transmitting signals. It may also include devices capable of receiving and transmitting signals. Examples include cellular devices or other communication devices, cellular devices or other communication devices with single line or multiple-line display(s) or without multiple-line display(s), PCS (Personal Communications Service) with the ability of processing voice, data, fax and/or data communications; PDA (Personal Digital Assistant) including radio frequency receivers, pagers, internet/intranet accessible devices, network browsers, notepads, or calendars, GPS (Global Positioning System) receivers; laptop and/or palmtop computers, and/or other devices that include a radio frequency receiver. The device may be portable, transportable, or installable into a vehicle (aviation, shipping and/or land), and may be configured to be operated in a given location, and/or a distributed location, or be operated on earth and/or any other location in space. The device may also include a communication terminal, internet access terminal, music/video play terminal such as a PDA and/or mobile phone, or a smart TV, top box and the like.

Person of the art should know that a remote network device as used herein includes but is not limited to computers, network hosts, a single network server, and cloud constructed of multiple network server sets or multiple servers. Here, the cloud is consisted of many computers or network servers based on cloud computing. Cloud computing is one kind of distributed computation, and is a super virtual computer consisted of a number of computers which are loosely coupled one another. In various embodiments of the invention, the remote network device, terminal device, and WNS may communicate with each other by any communication means, which include but is not limited to mobile communication based on 3GPP, LTE or WIMAX, computer network communication based on protocol such as TCP/IP or UDP, and near field wireless transmission based on Bluetooth or infra-red transmission standard.

The storage, storage unit or storage device as presented in this disclosure is used for storing the password and functions as the source of the password. The storage space is not limited to the local storage of a local terminal, but may also include storage at a remote server, for example being accessed through a local area network or the internet. Correspondingly, the verification process may be conducted in a local terminal to obtain the verification result. Or, related information may be transmitted to a remote server to receive the verification result and then forward the result to the local terminal. Those skilled in the art should understand these variations.

“Information unit” refers to a unit composed of at least one piece of information, or “information element.” The information unit (and hence, the constituent information elements) may be any one or a combination of character, color, font, font size, graphics, pattern or even a sound wave. For example, an information unit may be a character, or the combination of a character and a color. Alternatively, it may be the combination of a pattern and one or more colors. The information unit is not limited to any one or combination of character, color, font, font size, graphics, and pattern. “Character” has its ordinary and customary meaning and may include, but is not limited to, Chinese characters, English characters, Arab numbers, Roman numbers and the like. The information unit may be embodied by the computer as a unique code. For example ASC II code may be used for representing a character. As such, comparison operation of these codes may be conducted mathematically.

Unless otherwise specified, “password” or “predefined password” as used throughout the specification, refers to a password preset by the user. The password is generally composed of several information units arranged according to a certain sequence, for example a string of characters, or characters with color. In addition, the password is not a plain text password. The inventor believes that person of the art would completely understand above concepts when facing them.

Referring to FIG. 1, the present invention provides a method for fuzzily inputting password including several steps. The principle of the method is explained below with reference to detailed steps.

The method for fuzzily inputting password of the invention includes a step S11. In this step, a plurality of graph-text regions are displayed on a user interface and an information unit consisted of a number of information elements is mapped onto a respective graph-text region.

A set of information elements is predefined for selection by a user when inputting his password. Here, the password is a sequence of characters and is called a password sequence. It is noted that the password sequence means a single password consisted of a number of characters, while not meaning several passwords. The information element may be any one or combination of characters, fonts, font sizes, colors, graphics, or patterns.

At first, the predefined set of information elements are divided into a plurality of information units. In addition, it should be ensured that the information elements contained in each information unit are different from each other. Some or all information units contain at least two elements. The plurality of information units are randomly distributed and mapped onto each region according to a predefined number of graph-text regions. The number of the graph-text regions is flexibly determined by a system according to security requirement, and the number is suitably 4-6 for facilitating reasonable arrangement of them on a device display screen. The number of the information units is suitably same as the graph-text regions such that a region will correspond to a particular information unit. Different information unit may have different or same number of information elements.

The plurality of information elements of an information unit are randomly distributed into a plurality of graph-text layers of a corresponding graph-text region. A graph-text region contains a plurality of graph-text layers each of which is associated with a corresponding information element. A user interface, i.e., a touch screen, displays the plurality of graph-text regions, and displays corresponding information units as sets of information elements of graph or codified type on the user interface at locations where the graph-text regions are displayed. The plurality of graph-text layers of each graph-text region overlap with each other to produce a 3-D perspective view. The uppermost graph-text layer of each graph-text region is shown with its information elements. Of course, as another embodiment, the uppermost graph-text layer of the region may be an independent mask layer without any information elements being displayed. It is proper for these graph-text layers of a graph-text region to have the same size and shape for example rectangular, parallelogram, diamond, or other kinds of geometry. The graph-text layers of a specific graph-text region preferably share a common central axis and overlap with each other. Each graph-text region is consisted of a number of graph-text layers and is shown with a 3-D perspective view. The plurality of graph-text regions may have constant relative locations on the user interface. Alternatively, they may have real time changed locations on the user interface.

It should be noted that the displayed user interface realized in this step is only a primary displaying effect of the graph-text regions. The subsequent displaying effect of the regions will be changed over detection data of a gravity sensor.

The method for fuzzily inputting password of the invention includes a step S12. In this step, direction information detected by a gravity sensor is obtained. Upon change of the direction information, a displaying angle of each graph-text region on the user interface is changed to show the plurality of graph-text layers which are arranged at equal pitch. Each graph-text layer displays an information element of an information unit associated with the same graph-text region.

The direction information is obtained from the gravity sensor. When it is detected that a device of the present invention is orientated at a specific direction, the displaying angle of the graph-text region is correspondingly changed over the change of direction information. In other words, the graph-text region is displayed in an expanded manner from its one side corresponding to the detection data of the gravity sensor to show its graph-text layers with equal pitch. Here, each graph-text layer displays an information element of the information unit associated with said graph-text region. The pitch may be slightly adjusted according to requirement, and this is still within the scope of the invention.

Take a mobile phone terminal of Android system as an example. The detection of direction information of the gravity sensor may be implemented by following lines of codes:

private SensorManager sensorManager;
public void onSensorChanged(SensorEvent event)
{

if(event.sensor.getType( )==Sensor.TYPE_ACCELEROMETER)
{

float x = event.values[SensorManager.DATA_X];
float y = event.values[SensorManager.DATA_Y];
float z = event.values[SensorManager.DATA_Z];
orientation.setText(“x”, “y”, “z”);

}

}

As such, the current rotation direction of the mobile phone terminal is determined based on coordinates of the x-axis, y-axis, and z-axis thus obtained. As a result, it is able to know which graph-text region will be selected, and the information unit selected by the user may be determined based on this candidate graph-text region.

In this embodiment, the x-axis is parallel to a lateral axis of a plane of the mobile phone, y-axis is parallel to a longitudinal axis of the plane of the phone, while z-axis is perpendicular to the depth direction of the phone. For example, a graph-text region arranged at left side of the mobile phone plane is associated with an information unit {1,4,5} and contains three graph-text layers which respectively correspond three information elements 1, 4, and 5. When the mobile phone tilts toward the left, the gravity sensor will sense an angle toward the left. In this situation, if a direction toward the right is defined as a positive direction of the x-axis, a value along the x-axis will be a negative value, while a value along the y-axis represents a direction of left up or left down. In this case, regardless of the direction of y-axis, the graph-text region at left side is a subsequent graph-text region, which then will be expanded from the left side to show its various graph-text layers in a 3-D perspective view.

The method for fuzzily inputting password of the invention includes a step S13. In this step, in response to user instruction of selecting a particular graph-text region, a specific information unit mapped with the graph-text region is selected to verify whether a specific password character is identical to an information element of the unit.

The user may rotate the device of the present invention to determine whether a specific password character is contained in these graph-text layers. If yes, the user then clicks a top portion of the graph-text region to select a specific graph-text layer. In response to selection of multiple graph-text regions by the user, corresponding information units associated with said multiple regions are selected. Each of said information unit includes a plurality of information elements one of which is a password character predefined by the user.

When the input operation by the user is competed, an information unit sequence consisted of the plurality of inputted information units is verified. In detail, according to the order by which the information units are inputted, it is checked whether each information unit contains an information element identical to a corresponding predefined password character. If yes, the password verification is successful.

In other embodiments, the above password verification process may be performed on a cloud server. More particularly, the sequence consisted of the plurality of information units is contained in a verification request to form a data packet. The packet is sent to the cloud server through a remote interface, and then is parsed by the same server to get the inputted sequence of information units. After that, the password verification is conducted to know whether the inputted information units are correct.

In other embodiments, the above password verification process may be performed by other device such as an IC bankcard. In this situation, information transmission is realized by NFC (near field communication) technology, and the sequence of information units is sent to the IC card. Following a predefined program, the IC card compares the sequence of the information units with a predefined password stored therein, thus performing a password verification process. Of course, in other embodiments, the above password verification process may be performed by a smart terminal with Bluetooth function. The sequence of information units inputted by the user is delivered to the terminal through the Bluetooth function, and the terminal then performs password verification as described above, to determine whether the sequence of information units inputted by the user is correct.

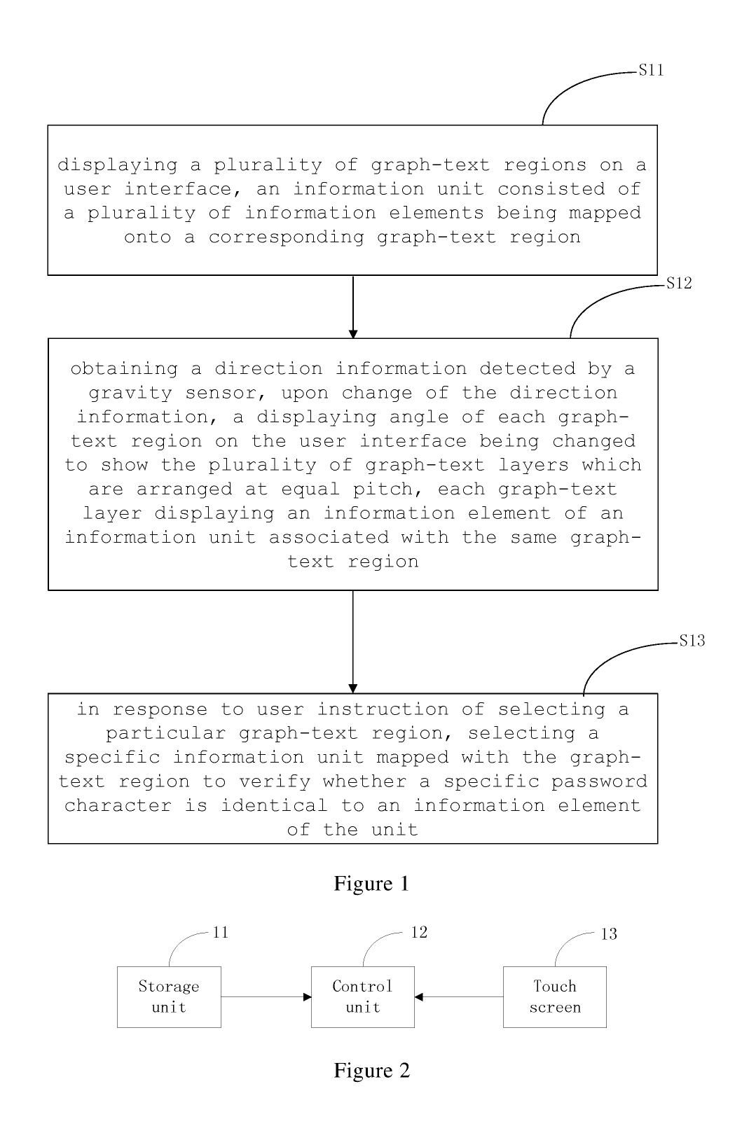

Please also refer to FIG. 2. The present invention further provides a device for fuzzily inputting password, which includes a control unit 11, a storage unit 12, and a touch screen 13.

The control unit 11 severs to provide comprehensive control and is mainly for executing a program implemented by the method for fuzzily inputting password of the invention, thus realizing password input operation. The storage unit 12 is used for permanently or temporarily storing kinds of intermediate data generated during a process of executing the program realized according to the method for fuzzily inputting password of the invention. For example, predefined graph-text regions or layers, sequence of information elements inputted by the user, candidate information unit or information unit to be selected subsequently might be stored. It may also store labels of the information unit of the program. Person of the art would understand that the password created by current method or user should be stored permanently (unless it should be changed when resetting). For the method of the invention, the program may flexibly determine whether other data should be stored by the storage unit. Accordingly, it should be understood that the storage technology used in current invention is by no means limited to the storage unit described herein. The touch screen 13 is intended for providing a plurality of graph-text regions. The graph-text regions are used for receiving selection of specific regions by the user and converting the selection of the regions to selection of corresponding information units. Moreover, the plurality of information elements contained in each graph-text region are those of the information unit mapped on the same region. Under coordination of the control unit 11, the device for fuzzily inputting password of the invention realizes human-machine interaction with sufficient use of the touch screen 13. By this manner, the password fuzzy input operation is done.

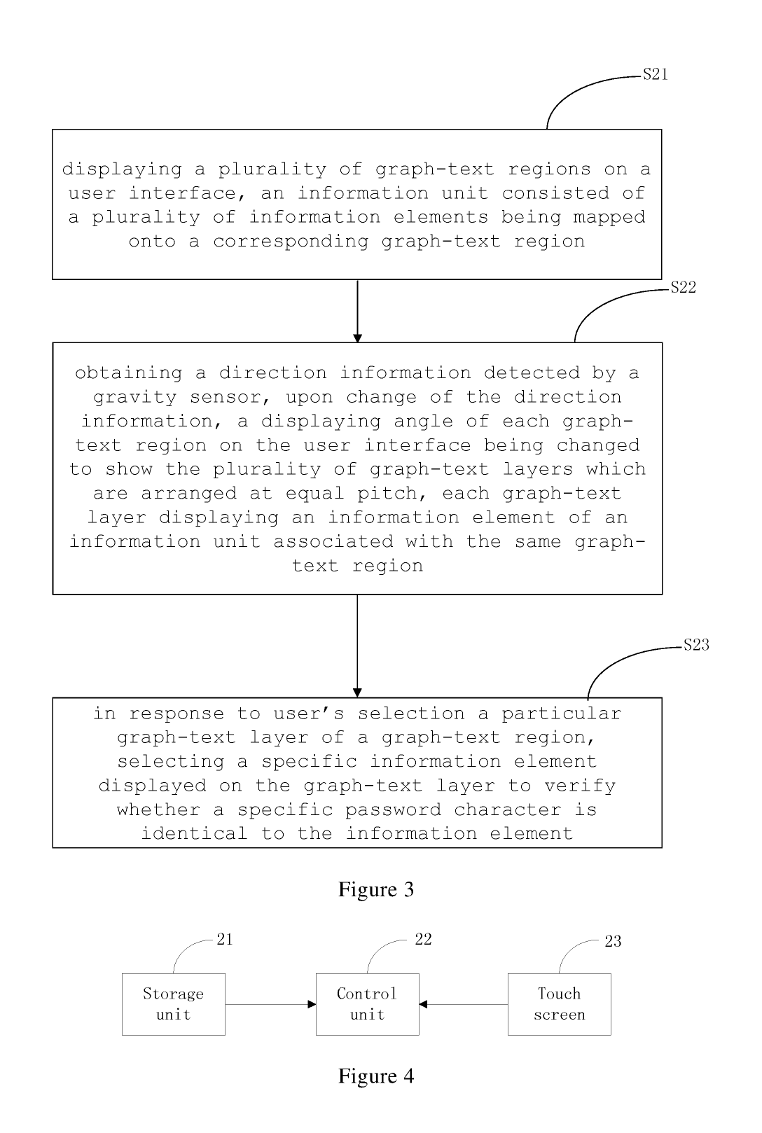

Referring to FIG. 3, according to another embodiment, the method for fuzzily inputting password of the invention includes a plurality steps and the principle of the method will be explained below with reference to these steps.

In step S21, a plurality of graph-text regions are displayed on a user interface and an information unit consisted of a number of information elements is mapped onto a respective graph-text region.

A set of information elements is predefined for selection by a user when inputting his password. Here, the password is a sequence of characters and is called a password sequence. It is noted that the password sequence means a single password consisted of a number of characters, while not meaning several passwords. The information element may be any one or combination of characters, fonts, font sizes, colors, graphics, or patterns.

At first, the predefined set of information elements are divided into a plurality of information units. In addition, it should be ensured that the information elements contained in each information unit are different from each other. Some or all information units contain at least two elements. The plurality of information units are randomly distributed and mapped onto each region according to a predefined number of graph-text regions. The number of the graph-text regions is flexibly determined by a system according to security requirement, and the number is suitably 4-6 for facilitating reasonable arrangement of them on a device display screen. The number of the information units is suitably same as the graph-text regions such that a region will correspond to a particular information unit. Different information unit may have different or same number of information elements.

The plurality of information elements of an information unit are randomly distributed into a plurality of graph-text layers of a corresponding graph-text region. A graph-text region contains a plurality of graph-text layers each of which is associated with a corresponding information element. A user interface, i.e., a touch screen, displays the plurality of graph-text regions, and displays corresponding information units as sets of information elements of graph or codified type on the user interface at locations where the graph-text regions are displayed. The plurality of graph-text layers of each graph-text region overlap with each other to produce a 3-D perspective view. The uppermost graph-text layer of each graph-text region is shown with its information elements. Of course, as another embodiment, the uppermost graph-text layer of the region may be an independent mask layer without any information elements being displayed. It is proper for these graph-text layers of a graph-text region to have the same size and shape for example rectangular, parallelogram, diamond, or other kinds of geometry. The graph-text layers of a specific graph-text region preferably share a common central axis and overlap with each other. Each graph-text region is consisted of a number of graph-text layers and is shown with a 3-D perspective view. The plurality of graph-text regions may have constant relative locations on the user interface. Alternatively, they may have real time changed locations on the user interface.

It should be noted that the displayed user interface realized in this step is only a primary displaying effect of the graph-text regions. The subsequent displaying effect of the regions will be changed over detection data of a gravity sensor.

In step S22, direction information detected by a gravity sensor is obtained. Upon change of the direction information, a displaying angle of each graph-text region on the user interface is changed to show the plurality of graph-text layers which are arranged at equal pitch. Each graph-text layer displays an information element of an information unit associated with the same graph-text region.

The direction information is obtained from the gravity sensor. When it is detected that a device of the present invention is orientated at a specific direction, the displaying angle of the graph-text region is correspondingly changed over the change of direction information. In other words, the graph-text region is displayed in an expanded manner from its one side corresponding to the detection data of the gravity sensor to show its graph-text layers with equal pitch. Here, each graph-text layer displays an information element of the information unit associated with said graph-text region.

Take a mobile phone terminal of Android system as an example. The detection of direction information of the gravity sensor may be implemented by following lines of codes:

private SensorManager sensorManager;
public void onSensorChanged(SensorEvent event)
{

if(event.sensor.getType( )==Sensor.TYPE_ACCELEROMETER)
{

float x = event.values[SensorManager.DATA_X];
float y = event.values[SensorManager.DATA_Y];
float z = event.values[SensorManager.DATA_Z];
orientation.setText(“x”, “y”, “z”);

}

}

As such, the current rotation direction of the mobile phone terminal is determined based on coordinates of the x-axis, y-axis, and z-axis thus obtained. As a result, it is able to know which graph-text region will be selected.

In this embodiment, the x-axis is parallel to a lateral axis of a plane of the mobile phone, y-axis is parallel to a longitudinal axis of the plane of the phone, while z-axis is perpendicular to the depth direction of the phone. For example, a graph-text region arranged at left side of the mobile phone plane is associated with an information unit {1,4,5} and contains three graph-text layers which respectively correspond three information elements 1, 4, and 5. When the mobile phone tilts toward the left, the gravity sensor will sense an angle toward the left. In this situation, if a direction toward the right is defined as a positive direction of the x-axis, a value along the x-axis will be a negative value, while a value along the y-axis represents a direction of left up or left down. In this case, regardless of the direction of y-axis, the graph-text region at left side is a subsequent graph-text region, which then will be expanded from the left side to show its various graph-text layers in a 3-D perspective view. The value of z-axis is for measuring distance along a depth direction of the graph-text layers when making selection.

Based on above selected graph-text region, the graph-text layers of the region receive selection instructions of the user. In other words, when the user presses any graph-text layer of the graph-text region, the strength of the pressing force will be sensed by the gravity sensor, thus knowing which one of the graph-text layers of the region forming a perspective is selected. For example, assume a graph-text region contains three graph-text layers. When the pressing strength value is lower than a threshold value 30, a first graph-text layer of the region will be selected. When the strength value is higher than the threshold value 30 while lower than another threshold value 60, a second graph-text layer of the region will be selected. When the pressing strength value is higher than the threshold value 60, a third graph-text layer of the region will be selected. As such, the graph-text layer selected by the user may be determined by detecting the pressing strength. In addition, during operation of the user, based on the distance of a specific graph-text layer relative to other layers inside the perspective view of the region, he is able to know the substantial pressing strength with which a desired graph-text layer can be accurately selected by the user, thus making it possible to precisely select a desired information element associated with a corresponding graph-text layer.

According to a step S23, in response to user instruction of selecting a particular graph-text region, a specific information unit mapped with the graph-text region is selected to verify whether a specific password character is identical to an information element of the unit.

The user may rotate the device of the present invention to determine whether a specific password character is contained in these graph-text layers. If yes, the user then clicks with certain strength a top portion of the graph-text region so that the gravity sensor will sense the strength and then identify the graph-text layer of the graph-text region selected by the user. In response to selection of multiple graph-text regions by the user, corresponding information units associated with said multiple regions are selected. Each of said information unit includes a plurality of information elements one of which is a password character predefined by the user.

When the input operation by the user is completed, an information unit sequence consisted of the plurality of inputted information units is verified. In detail, according to the order by which the information units are inputted, it is checked whether each information unit contains an information element identical to a corresponding predefined password character. If yes, the password verification is successful.

In other embodiments, the above password verification process may be performed on a cloud server. More particularly, the sequence consisted of the plurality of information units is contained in a verification request to form a data packet. The packet is sent to the cloud server through a remote interface, and then is parsed by the same server to get the inputted sequence of information units. After that, the password verification is conducted to know whether the inputted information units are correct.

In other embodiments, the above password verification process may be performed by other device such as an IC bankcard. In this situation, information transmission is realized by NFC (near field communication) technology, and the sequence of information units is sent to the IC card. Following a predefined program, the IC card compares the sequence of the information units with a predefined password stored therein, thus performing a password verification process. Of course, in other embodiments, the above password verification process may be performed by a smart terminal with Bluetooth function. The sequence of information units inputted by the user is delivered to the terminal through the Bluetooth function, and the terminal then performs password verification as described above, to determine whether the sequence of information units inputted by the user is correct.

Please also refer to FIG. 4. The present invention further provides a device for fuzzily inputting password, which includes a control unit 21, a storage unit 22, and a touch screen 23.

The control unit 21 severs to provide comprehensive control and is mainly for executing a program implemented by the method for fuzzily inputting password of the invention, thus realizing password input operation. The storage unit 22 is used for permanently or temporarily storing kinds of intermediate data generated during a process of executing the program realized according to the method for fuzzily inputting password of the invention. For example, predefined graph-text regions or layers, sequence of information elements inputted by the user, candidate information unit or information unit to be selected subsequently might be stored. It may also store labels of the information unit of the program. Person of the art would understand that the password created by current method or user should be stored permanently (unless it should be changed when resetting). For the method of the invention, the program may flexibly determine whether other data should be stored by the storage unit. Accordingly, it should be understood that the storage technology used in current invention is by no means limited to the storage unit described herein. The touch screen 23 is intended for providing a plurality of graph-text regions. The graph-text regions are used for receiving selection of specific regions by the user and converting the selection of the regions to selection of corresponding information units. Moreover, selection of a specific graph-text layer by the user is determined by detecting the user's pressing strength of specific graph-text region on the touch screen. Under coordination of the control unit 11, the device for fuzzily inputting password of the invention realizes human-machine interaction with sufficient use of the touch screen 23. By this manner, the password fuzzy input operation is done.

In a summary, the present invention employs a plurality of graph-text regions each of which further contains a plurality of graph-text layers. Different information units are distributed in different graph-text regions. Each graph-text region is associated with an information unit consisted of a plurality of information elements. Selection of any graph-text region is associated with selection of a corresponding information unit containing a plurality of information elements. In addition, selection of an individual information element is realized by selection of a graph-text region consisted of a plurality of graph-text elements including the one to be selected, thus strongly improving fuzziness of password input, avoiding leakage of the password during inputting process, and enhancing safety of the entire password inputting process.

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

1. A method for fuzzily inputting password, for inputting a password character during verification of a predefined password, comprising the following steps:
displaying a plurality of graph-text regions on a user interface, an information unit consisted of a plurality of information elements being mapped onto a corresponding graph-text region;
obtaining a direction information detected by a gravity sensor, upon change of the direction information, a displaying angle of each graph-text region on the user interface being changed to show the plurality of graph-text layers which are arranged at equal pitch, each graph-text layer displaying an information element of an information unit associated with the same graph-text region; and
in response to user's selection a particular graph-text region, selecting a specific information unit mapped with the graph-text region to verify whether a specific password character is identical to an information element of the unit.

2. The method of claim 1, wherein the plurality of graph-text layer of a graph-text region is planes sharing a common central axis.

3. The method of claim 1, wherein a number of information elements are randomly contained in said plurality of information units such that the information elements contained in a specific information unit are different from each other.

4. The method of claim 1, wherein each information unit is displayed as a set of information elements of graph or codified type on a user interface at a location where a corresponding graph-text region locates.

5. The method of claim 1, wherein each information unit contains at least two information elements.

6. The method of claim 5, wherein the information elements are any one or a combination of character, color, font, font size, graphics or pattern.

7. The method of claim 1, wherein different information unit has different or same number of information elements.

8. The method of claim 1, wherein further comprising a step of placing a sequence consisted of the plurality of information units, which are sequentially inputted in accordance with the number of the password characters, into a verification request, and submitting the verification request through a remote interface.

9. The method of claim 1, wherein the user interface is provided by a touch screen.

10. The method of claim 1, wherein the plurality of graph-text regions are displayed on the user interface with their locations unchanged.

11. The method of claim 1, wherein the plurality of graph-text regions are displayed on the user interface with their locations dynamically changed in real time.

12. A device for fuzzily inputting password for realizing the method as recited in claim 1, comprising:
a control unit for executing a program embodying the method;
a storage unit for storing intermediate and result data generated during a process of executing the program realized according to the method; and
a touch screen for providing a displaying area for showing the plurality of graph-text regions and receiving selection instruction of the user.

13. A method for fuzzily inputting password, for inputting a password character during verification of a predefined password, comprising the following steps:
displaying a plurality of graph-text regions on a user interface, an information unit consisted of a plurality of information elements being mapped onto a corresponding graph-text region;
obtaining a direction information detected by a gravity sensor, upon change of the direction information, a displaying angle of each graph-text region on the user interface being changed to show the plurality of graph-text layers which are arranged at equal pitch, each graph-text layer displaying an information element of an information unit associated with the same graph-text region; and
in response to user's selection a particular graph-text layer of a graph-text region, selecting a specific information element displayed on the graph-text layer to verify whether a specific password character is identical to the information element.

14. The method of claim 13, wherein the plurality of graph-text layer of a graph-text region are displayed with equal pitch along a common central axis, and an information element of an information unit corresponding to the graph-text region is displayed on a corresponding graph-text layer.

15. The method of claim 14, wherein a corresponding graph-text layer receives selection instruction of the user to determine the selected information element.

16. The method of claim 15, wherein receiving the selection instruction of the user is realized by sensing pressing strength of the user on a graph-text layer by a gravity sensor to determine the graph-text layer selected by the user, thus determining the information element corresponding to the same graph-text layer.

17. The method of claim 13, wherein a number of information elements are randomly contained in said plurality of information units such that the information elements contained in a specific information unit are different from each other.

18. The method of claim 13, wherein each information unit contains at least two information elements.

19. The method of claim 18, wherein the information elements are any one or a combination of character, color, font, font size, graphics or pattern.

20. The method of claim 13, wherein different information unit has different or same number of information elements.

21. The method of claim 13, wherein each information unit is displayed as a set of information elements of graph or codified type on a user interface at a location where a corresponding graph-text region locates.

22. The method of claim 13, wherein further comprising a step of placing a sequence consisted of the plurality of information units, which are sequentially inputted in accordance with the number of the password characters, into a verification request, and submitting the verification request through a remote interface.

23. A device for fuzzily inputting password for realizing the method as recited in claim 13, comprising:
a control unit for executing a program embodying the method;
a storage unit for storing intermediate and result data generated during a process of executing the program realized according to the method; and
a touch screen for providing a displaying area for showing the plurality of graph-text regions and receiving selection instruction of the user.
